(19) United States
(12) Patent Application Publication
(10) Pub. No.: US 2026/0006257 A1
(43) Pub. Date: Jan. 1, 2026

(54) VIDEO CODING APPARATUS AND DECODING APPARATUS

(71) Applicant: SHARP KABUSHIKI KAISHA, Osaka (JP)

(72) Inventors: TAKESHI CHUJOH, Osaka (JP); TOMOHIRO IKAI, Osaka (JP); Zheming FAN, Osaka (JP); Sujun HONG, Osaka (JP)

(21) Appl. No.: 19/249,668

(22) Filed: Jun. 25, 2025

(30) Foreign Application Priority Data
Jun. 28, 2024 (JP) 2024-105368
Jul. 8, 2024 (JP) 2024-109461

(51) Int. Cl. H04N 19/85; H04N 19/70; H04N 19/80

(52) U.S. Cl. CPC H04N 19/85; H04N 19/70; H04N 19/80

(57) ABSTRACT

A video decoding apparatus includes: an image decoding apparatus that decodes coded data of an image signal; a generative information decoding apparatus that decodes generative information from generated coded data, a tag URI for identifying a format of the generative information, information acquired from a URI for identifying the generative information, and image information decoded by the image decoding apparatus; and an image generation apparatus that generates an image from the image information decoded by the image decoding apparatus and the generative information decoded by the generative information decoding apparatus.

### TECHNICAL FIELD

Embodiments of the present invention relate to a video coding apparatus and a decoding apparatus.

### BACKGROUND ART

A video coding apparatus which generates coded data by coding an image, and a video decoding apparatus which generates a decoded image by decoding the coded data are used for efficient transmission or recording of videos.

Specific video coding schemes include, for example, the H.266/Versatile Video Coding (VVC) scheme and the like.

In such traditional image coding schemes, an image is divided to be coded/decoded. First, a prediction image is generated based on a locally decoded image obtained by coding an input image/decoding coded data. Next, a prediction error obtained by subtracting the prediction image from the input image (original image) (which may be referred to as a “difference image” or a “residual image”) is coded/decoded.

Meanwhile, in recent years, as an image generation method using a neural network, a method of generative AI using a diffusion model, which is referred to as Stable Diffusion, is disclosed. In the method, an image can be generated based on text input by a user, which is referred to as a prompt.

As video coding and decoding technology, NPL 1 defines a supplemental extension information (Supplemental Enhancement Information) (SEI) message for transmitting image properties, a display method, timings, and the like simultaneously with coded data. A Neural-Network Post-filter Activation SEI message indicating application of post-filter processing based on a neural network is presented.

NPL 2 proposes an SEI message that can be targeted for a purpose of any application through an extension of the method of NPL 1.

### CITATION LIST

### Non Patent Literature

NPL 1: ITU-T Rec. H.274 V3 “Versatile supplemental enhancement information messages for coded video bitstreams”
NPL 2: J. Boyce, J. Chen, S. Deshpande, M. M. Hannuksela, Hendry, S. McCarthy, G. J. Sullivan and Y.-K. Wang, “Additional SEI messages for VSEI version 4 (Draft 2),” JVET Document, JVET-AH2006-v1, April 2024.

### SUMMARY OF INVENTION

### Technical Problem

The method disclosed in NPL 1 does not support neural network image processing performed by generative AI using text information of a prompt. Although the method disclosed in NPL 2 enables definition of the purpose of any application, there has been a problem in that how to define information required by such a specific application is unknown. Thus, for example, in a case that neural network image processing using generative AI is applied or the like, a prompt, which is text information, and a model and a control parameter necessary for defining other processing are required, but how to define those has been unknown.

In NPL 2, there has been a problem in that a syntax element for defining the purpose of an application is not byte-aligned despite being character string information.

In NPL 1 and NPL 2, there has been a problem in that syntax of a Neural Network Post-Filter Activation SEI message for defining application of the neural network cannot be extended.

### Solution to Problem

A video decoding apparatus according to an aspect of the present invention includes: an image decoding apparatus configured to decode coded data of an image signal; a generative information decoding apparatus configured to decode generative information from generated coded data, a tag URI for identifying a format of the generative information, information acquired from a URI for identifying the generative information, and image information decoded by the image decoding apparatus; and an image generation apparatus configured to generate an image from the image information decoded by the image decoding apparatus and the generative information decoded by the generative information decoding apparatus.

### Advantageous Effects of Invention

Employing the configuration as described above can solve a problem of efficiently implementing video coding and decoding by using an image generation method.

### BRIEF DESCRIPTION OF DRAWINGS

FIG. 1 is a schematic diagram illustrating a configuration of an image transmission system according to the present embodiment.

FIG. 2 is a diagram illustrating an example of a block diagram of an image generation processing apparatus according to the present embodiment.

FIG. 3 is a diagram illustrating an example of a block diagram of a generative information creation apparatus according to the present embodiment.

FIG. 4 is a diagram illustrating an example of a block diagram of a generative information coding apparatus according to the present embodiment.

FIG. 5 is a diagram illustrating an example of a block diagram of a generative information decoding apparatus according to the present embodiment.

FIG. 6 is a diagram illustrating syntax of an NNPFC SEI message described in NPL 2.

FIG. 7 is a diagram illustrating an example of an extension of the NNPFC SEI message according to the present embodiment.

FIG. 8 is a diagram illustrating an example of another extension of the NNPFC SEI message according to the present embodiment.

FIG. 9 is a diagram illustrating an example of an extension of an NNPFAE SEI message according to the present embodiment.

FIG. 10 is a diagram illustrating an example of another extension of the NNPFC SEI message according to the present embodiment.

FIG. 11 is a diagram illustrating an example of another extension of the NNPFC SEI message according to the present embodiment.

FIG. 12 is a diagram illustrating an example of another extension of the NNPFC SEI message according to the present embodiment.

### Description of Embodiments

### First Embodiment

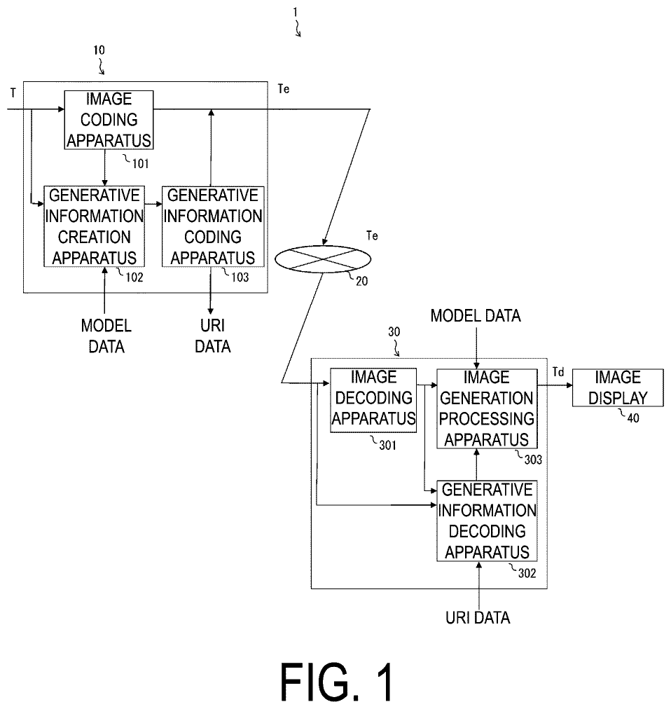

FIG. 1 is a conceptual diagram illustrating a configuration of an image transmission system according to the present embodiment.

The image transmission system 1 includes a video coding apparatus 10, a transmission network 20, a video decoding apparatus 30, and an image display apparatus 40.

The video coding apparatus 10 receives an input of an input image signal T, and outputs coded data Te.

The transmission network 20 transmits the coded data Te from the video coding apparatus 10 to the video decoding apparatus 30. The transmission network 20 is the Internet, a Wide Area Network (WAN), a Local Area Network (LAN), or a combination thereof. The transmission network 20 is not limited to a bidirectional communication network and may be a unidirectional communication network that transmits broadcast waves for terrestrial digital broadcasting, satellite broadcasting, or the like. The transmission network 20 may be substituted with a storage medium in which the coded data Te is recorded, such as a Digital Versatile Disc (DVD) (trade name) or a Blu-ray Disc (BD) (trade name).

The video decoding apparatus 30 receives an input of the coded data Te, outputs a generated image Td, and transmits the generated image Td to the image display apparatus 40.

The image display apparatus 40 displays all or a part of the generated image Td output from the video decoding apparatus 30. For example, the image display apparatus 40 includes a display device such as a liquid crystal display and an organic Electro-luminescence (EL) display. Examples of display types include stationary, mobile, and HMD. In a case that the video decoding apparatus 30 has a high processing capability, an image having high image quality is displayed, and in a case that the video decoding apparatus 30 has a lower processing capability, an image which does not require high processing capability and display capability is displayed.

The video coding apparatus 10 includes an image coding apparatus 101, a generative information creation apparatus 102, and a generative information coding apparatus 103.

The image coding apparatus 101 codes the input image signal T and creates the coded data Te, and transmits decoded image information to the generative information creation apparatus 102.

The generative information creation apparatus 102 receives an input of the input image signal T, model data from the outside, and the decoded image information from the video coding apparatus, and creates generative information and transmits the generative information to the generative information coding apparatus 103.

The generative information coding apparatus 103 codes the generative information, saves the generative information as URI data at a specified Uniform Resource Identifier (URI) in a network server or a specific storage location, and generates supplemental extension information coded data including the URI. The URI is a character string for identifying an abstract or physical resource, and the URI defined in RFC 2396 or RFC 3986 may be used. The URI may be a name of information such as a Uniform Resource Name (URN), or may be a location of information such as a Uniform Resource Locator (URL).

The video decoding apparatus 30 includes an image decoding apparatus 301, a generative information decoding apparatus 302, and an image generation processing apparatus 303.

The image decoding apparatus 301 receives an input of the coded data Te transmitted via the transmission network 20, decodes the image information, and transmits the image information to the generative information decoding apparatus 302 and the image generation processing apparatus 303.

The generative information decoding apparatus 302 decodes supplemental extension information of the coded data Te based on syntax, creates the generative information based on the image information created by the image decoding apparatus 301 and the decoded URI by loading the URI data from the stored location (the network server or the specific storage location), and transmits the generative information to the image generation apparatus 301.

The image generation processing apparatus 303 performs image generation processing based on the image information decoded in the image decoding apparatus 301, the generative information decoded in the generative information decoding apparatus 302, and the model data from the outside, generates the generated image Td, and outputs the generated image Td to the image display apparatus 40.

In the present embodiment, the image coding apparatus 101 and the image decoding apparatus 301 are implemented by applying multi-purpose video coding and decoding schemes, such as AVC, HEVC, and VVC.

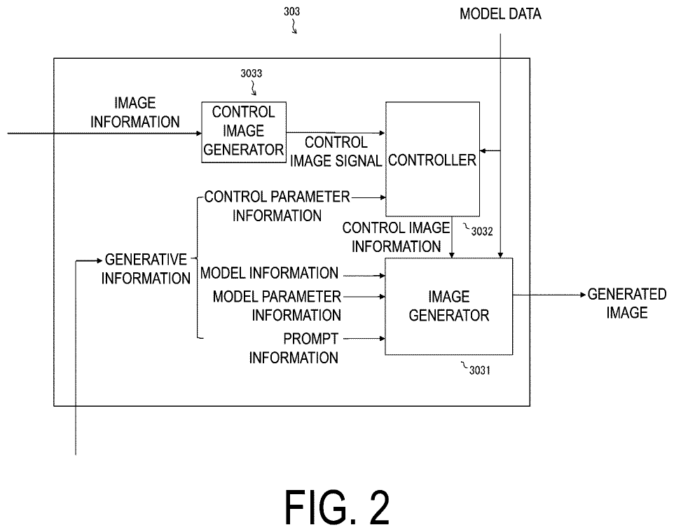

FIG. 2 is a conceptual diagram illustrating a configuration of the image generation processing apparatus according to the present embodiment. The image generation processing apparatus according to the present embodiment uses a generation image processing method based on so-called image generative AI including a neural network such as a diffusion model. The image generation processing apparatus receives an input of the image information, the generative information, and the model data, and outputs the generated image.

The image generation processing apparatus 303 includes an image generator 3031, a controller 3032, and a control image generator 3033. The image generator 3031 uses a generation image processing method including a neural network of Stable Diffusion. The controller 3032 uses a control method including a neural network referred to as ControlNet. The control image generator 3033 generates a control image signal from the image information.

The controller 3032 receives an input of the image information, control parameter information in the generative information, and the model data specified by control parameters, and outputs control image information to be input to the image generator 3031. Here, the image information is a locally decoded image signal output by the image coding apparatus 101 or a decoded image signal output by the image decoding apparatus 301.

Both of these are image information obtained by coding or decoding the input image signal.

The control image signal is created from the image information in the control image generator 3033. Specifically, the control image signal uses the following pieces of information. These identifications are included in the control parameters.
Canny image
Soft edge image
Sketch image
Line art image
Normal map image
Depth map image
Segmentation image
Open Pose (OpenPose) image
Wireframe (MLSD) image
Inpaint image
Reference image

All of these are monochrome or color image information created by using an image. Note that the control image signal is not limited to one image, and multiple different control image signals may be present for the same image information.

The generative information includes control parameter information, model information, model parameter information, prompt information, and the like.

The control parameter information is parameter(s) for controlling the controller 3032 described above, and includes identification of a base image of the image information, identification of a control image, model information of the controller, and the like.

The model information is a neural network model name and neural network model data to be used for image generation in the image generator 3301. The model data is, by being shared by the video coding apparatus 10 and the video decoding apparatus 30 as URI information, input to the image generation processing apparatus 303 as the model data from the outside. Alternatively, the video coding apparatus 10 and the video decoding apparatus 30 may include the same model data in advance.

The model parameter(s) are parameter(s) for controlling the neural network, and are various numerical values, such as a strength value, the number of steps, a sampler type, and seed information, and character string information.

The prompt information is character string information indicating contents of the generated image. The prompt information includes positive prompt information indicating contents to be generated and negative prompt information indicating contents not to be generated.

The positive prompt information can be automatically generated by performing image analysis on the input image signal. The positive prompt information can be automatically generated by performing image analysis on the image information decoded in the image coding apparatus 101 or the image decoding apparatus 301. For the positive prompt, information created from the input image signal may be directly coded or decoded as a part of the generative information. Alternatively, in a case that information created from the image information is used, it can be created in the generative information decoding apparatus 302, and thus mode information indicating thereof may be transmitted. Alternatively, by coding a difference between the information created from the input image signal and the information created from the image information as a part of the generative information and using the information created in the video decoding apparatus 30, the information created from the input image signal may be decoded.

The negative prompt information may be coded or decoded as a part of additional generative information in a case that the video coding apparatus 10 and the video decoding apparatus 30 include common information and additional information needs to be transmitted.

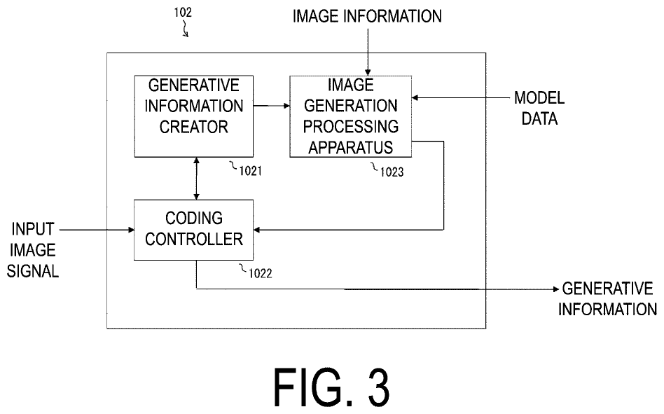

FIG. 3 is a block diagram illustrating a configuration of the generative information creation apparatus 102 according to the present embodiment. The generative information creation apparatus 102 according to the present embodiment receives an input of the input image signal, the image information created in the video coding apparatus 10, and the model data from the outside, outputs the generative information, and transmits the generative information to the generative information coding apparatus 103.

The generative information creation apparatus 102 includes a generative information creator 1021, a coding controller 1022, and an image generation processing apparatus 1023. The image generation processing apparatus 1023 is the same as the image generation processing apparatus 303 described above, and outputs the generated image from the generative information, the image information, and the model data. The coding controller 1032 selects the generative information created with reference to two indicators, namely an evaluation criterion D of image similarity based on comparison between the generated image results and the input image signal of the image generation apparatus 303, such as a mean squared error, an absolute value error sum, Structural Similarity (SSIM), Multi-Scale Structural Similarity (MS-SSIM), and Learned Perceptual Image Patch Similarity (LPIPS), and a code amount R of the generative information created by the generative information creator 1021, and outputs optimal generative information.

The generative information creator 1021 generates the generative information through exchange of information with the coding controller 1022, and transmits the generative information to the image generation processing apparatus 1023.

The generative information coding apparatus 103 codes the generative information created by the generative information creation apparatus 102, and transmits the supplemental extension information coded data together with the coded data output by the image coding apparatus 101 as the coded data Te to the transmission network 20 that has created the coded data Te.

The generative information decoding apparatus 302 decodes the supplemental extension information coded data in the coded data Te transmitted from the transmission network 20, and transmits the decoded results to the image generation processing apparatus 303 as the generative information.

In the present embodiment, coding and decoding are performed as a Supplemental Enhancement Information (SEI) message, based on syntax to be described later. Note that the coding and decoding schemes are not limited to the SEI message, and coding and decoding may be performed as syntax, for example, an Adaptation Parameter Set (APS) or the like, in video coding and decoding schemes.

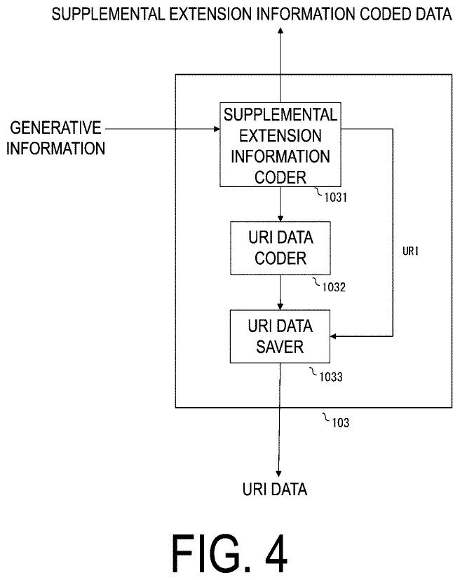

FIG. 4 is a block diagram illustrating a configuration of the generative information coding apparatus 103 according to the present embodiment. The generative information coding apparatus 103 according to the present embodiment includes a supplemental extension information coder 1031, a URI data coder 1032, and a URI data saver 1033.

The supplemental extension information coder 1031 defines an identifier for the generative information generated in the generative information creation apparatus 102 as a Uniform Resource Identifier (URI), creates the supplemental extension information coded data as the SEI message to be described later, and transmits the supplemental extension information coded data as a part of the coded data Te to the transmission network 20.

The URI data coder 1032 codes contents of the generative information whose identifier is defined in the supplemental extension information coder 1031 into URI data as text information or text-compressed data, and transmits the URI data to the URI data saver 1033.

The URI data saver 1033 saves the URI data, which is the URI data coded in the URI data coder 1032, at the URI defined in the supplemental extension information coder 1031 in a location (a network server or a specific storage location) indicated by the URI.

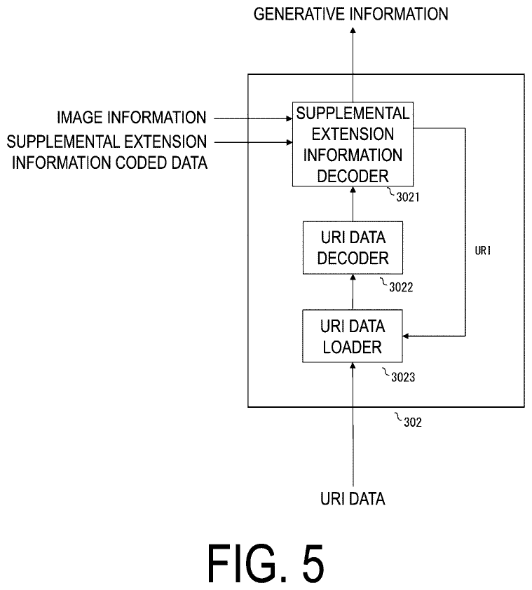

FIG. 5 is a block diagram illustrating a configuration of the generative information decoding apparatus 302 according to the present embodiment. The generative information decoding apparatus 302 according to the present embodiment includes a supplemental extension information decoder 3021, a URI data decoder 3022, and a URI data loader 3023.

The supplemental extension information decoder 3021 decodes the supplemental extension information coded data of the coded data Te received from the transmission network 20. The supplemental extension information coded data being coded as the SEI message to be described later is decoded, and the decoded URI is transmitted to the URI data loader 3023.

The URI data loader 3023 loads the coded URI data from the stored location (the network server or the specific storage location) based on the URI decoded by the supplemental extension information decoder 3021.

The URI data decoder 3022 decodes the generative information from the loaded URI data, and transmits the generative information to the supplemental extension information decoder 3021.

The supplemental extension information decoder 3021 combines the generative information created from the image information of the image decoding apparatus 301, decoded results of the supplemental extension information coded data, and decoded results of the generative information from the URI data, and outputs the generative information to the image generation processing apparatus 303 as final results.

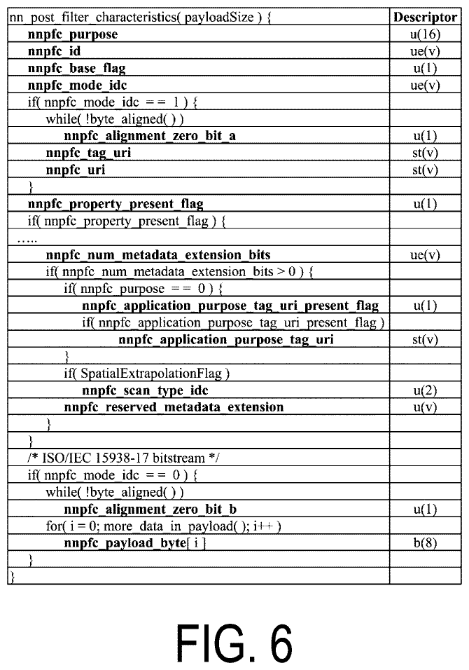

FIGS. 6, 7, 8, and 9 illustrate syntax of the generative information coded data coded and decoded in the generative information coding apparatus 103 and the generative information decoding apparatus 302 according to the present embodiment.

Note that the meaning of a notation of “Descriptor” in the following syntax tables is interpreted as follows.
b(8): indicates a value of a byte having any pattern of a bit string (8 bits).
f(n): indicates a bit character string having a fixed pattern using n bits written sequentially from the left bit (from left to right).
se(v): indicates a syntax element obtained by performing 0-order Exp-Golomb coding on a signed integer.
st(v): indicates a character string coded by UTF-8 and terminated with null.
u(n): indicates an unsigned integer using n bits. In a case that n is “v” in the syntax table, the number of bits varies depending on values of other syntax elements.
ue(v): indicates a syntax element obtained by performing 0-order Exp-Golomb coding on an unsigned integer (left bit first).

FIG. 6 is a part of syntax of a Neural Network Post-Filter Characteristic SEI message (NNPFC SEI message) in NPL 2. With the SEI message, as the extension information, tag information related to the purpose of an application can be transmitted.

The syntax elements of FIG. 6 will be described below.

A syntax element nnpfc_purpose indicates a purpose of an NNPF. Here, in a case that (nnpfc_purpose & bitMask) is not 0, it indicates that the NNPF has a purpose associated with the bitMask value. In a case that the value of nnpfc_purpose is greater than 0 and the value of (nnpfc_purpose & bitMask) is 0, the purpose associated with the bitMask value is not applied to the NNPF. In a case that the bitMask value is 0x01, the purpose is improvement in general visual quality.

In a case that the bitMask value is 0x02, the purpose is upsampling of a chroma signal (from the 4:2:0 format to the 4:2:2 or 4:4:4 format, or from the 4:2:2 format to the 4:4:4 format).

In a case that the bitMask value is 0x04, the purpose is resampling of resolution (expansion or reduction of resolution in width or height).

In a case that the bitMask value is 0x08, the purpose is upsampling of a picture rate.

In a case that the bitMask value is 0x10, the purpose is upsampling of pixel bit-depth (increase of bit-depth of luma pixels or bit-depth of chroma pixels).

In a case that the bitMask value is 0x20, the purpose is colorization of a monochrome image.

In a case that the bitMask value is 0x40, the purpose is temporal extrapolation (generation of one or more future images).

In a case that the bitMask value is 0x80, the purpose is spatial extrapolation (generation of contents outside a spatial region of an input image).

In a case that the value of nnpfc_purpose is 0, the NNPF is determined by an application, and can be used as specified by nnpfc_application_purpose_tag_uri.

All the NNPFC SEI messages having a specific value of nnpfc_id in a CLVS need to have the same value of nnpfc_purpose. In the bitstream conforming to the version of this specification, the values of nnpfc_purpose need to be in a range of 0 to 255. The values of nnpfc_purpose of 256 to 65535 are reserved for future use, and are not present in the bitstream conforming to the version of this specification. The decoder conforming to the version of this specification ignores the NNPFC SEI message whose nnpfc_purpose is in a range of 256 to 65535.

Note that although the method of NPL 2 enables definition of the purpose of any application through introduction of the syntax element nnpfc_application_purpose_tag_uri, the syntax element nnpfc_purpose may be extended.

Specifically, for example, in a case that the bitMask value is 0x0100, the purpose may be neural network post-filter processing using generative AI.

The syntax element nnpfc_id indicates an identification number available for identifying the NNPF. The values of nnpfc_id need to be in a range of 0 to 2 to the 32nd power minus 2. The values of nnpfc_id in ranges of 256 to 511 and 2 to the 31st power to 2 to the 32nd power minus 2 are reserved for future use. In a case of encountering the NNPFC SEI message whose nnpfc_id is in a range of 256 to 511 or 2 to the 31st power to 2 to the 32nd power minus 2, the decoder conforming to the version of this specification ignores the SEI message.

In a case that the NNPFC SEI message is a first NNPFC SEI message having a specific nnpfc_id value in the current CLVS in decoding order, the following is applied.
The SEI message defines a base NNPF.
The SEI message applies to the current decoded picture and all the subsequent decoded pictures in the current layer in output order until the end of the current CLVS.

A syntax element nnpfc_base_flag is a flag indicating whether or not the SEI message is the base NNPF. In a case that the value of nnpfc_base_flag is 1, it indicates that the SEI message is the base NNPF. In a case that the value of nnpfc_base_flag is 0, it indicates that the SEI message is an update for the base NNPF.

The value of nnpfc_base_flag is subject to the following constraints.
In a case that the NNPFC SEI message is a first NNPFC SEI message having a specific nnpfc_id value in the current CLVS in decoding order, the value of nnpfc_base_flag needs to be 1.
All the NNPFC SEI messages having a specific nnpfc_id value in the CLVS whose value of nnpfc_base_flag is 1 need to be the same.

In a case that the value of nnpfc_base_flag is 0, the following is applied.
The SEI message defines an update for a preceding base NNPF having the same nnpfc_id value in decoding order. The update is not cumulative, and each update is applied to the base NNPF having a specific nnpfc_id value in the current CLVS for the first NNPFC SEI message in decoding order. The NNPF defined in the SEI message is acquired by applying the update defined in the SEI message to the base NNPF having the same nnpfc_id value.
The SEI message is applied to the current decoded picture and all the subsequent decoded pictures in the current layer. The output order is until the end of the current CLVS or until the earlier one of the pictures associated with the subsequent NNPFC SEI message having a specific nnpfc_id value in the current CLVS whose nnpfc_base_flag is 0 in the decoding order in the current CLVS except for the decoded pictures subsequent to the current decoded picture in output order in the current CLVS.

A syntax element nnpfc_mode_idc is a value for identifying neural network information. In a case that the value of nnpfc_mode_idc is 0, it indicates that the neural network information is included in the NNPFC SEI message, and the neural network information is in the format of the ISO/IEC 15938-17 bitstream. In a case that the value of nnpfc_mode_idc is 1, it indicates that the neural network information is in the format identified by a tag URI nnpfc_tag_uri, and is identified by the URI indicated by nnpfc_uri. The values of nnpfc_mode_idc need to be in a range of 0 to 255. The values of nnpfc_mode_idc of 2 to 255 are reserved for future use, and are not present in the bitstream conforming to the version of this specification. The decoder conforming to the version of this specification ignores the NNPFC SEI message whose nnpfc_mode_idc is in a range of 2 to 255.

The value of a syntax element nnpfc_alignment_zero_bit_a needs to be 0.

The syntax element indicates a tag URI. nnpfc_tag_uri includes a tag URI having syntax and semantics defined in IETF RFC 4151, and indicates the format of the neural network used as the base NNPF and its related information, or update information to be applied to the base NNPF having the same nnpfc_id value as that specified by nnpfc_uri. Note that, in a case that nnpfc_tag_uri is used, the format of the neural network data specified by nnpfc_uri can be uniquely identified without the need of a central registration entity. In a case that nnpfc_tag_uri is equal to “tag: iso.org, 2023:15938-17”, it indicates that the neural network data identified by nnpfc_uri conforms to ISO/IEC 15938-17.

nnpfc_uri includes a URI having syntax and semantics specified in IETF Internet Standard 66, and indicates the neural network used as the base NNPF or, update information for the base NNPF having the same nnpfc_id value.

A syntax element nnpfc_num_metadata_extension_bits indicates the number of bits extended for metadata. In a case that nnpfc_num_metadata_extension_bits is 0, it indicates that nnpfc_reserved_metadata_extension is not present. In a case that nnpfc_num_metadata_extension_bits is greater than 0, a variable numSpecifiedMetadataExtensionBits is the number of bits indicating all syntax elements between nnpfc_num_metadata_extension_bits and nnpfc_reserved_metadata_extension.

In a case that nnpfc_num_metadata_extension_bits is greater than 0, it specifies the sum of lengths (in bits) of numSpecifiedMetadataExtensionBits and nnpfc_reserved_metadata_extension. The values of nnpfc_num_metadata_extension_bits need to be in a range of numSpecifiedMetadataExtensionBits to 2048. The values of nnpfc_num_metadata_extension_bits in a range of numSpecifiedMetadataExtensionBits+1 to 2048 are reserved for future use, and are not present in the bitstream conforming to the version of this specification. The decoder conforming to the version of this specification allows any value of nnpfc_num_metadata_extension_bits in a range of 0 to numSpecifiedMetadataExtensionBits +1 to 2048.

A syntax element nnpfc_application_purpose_tag_uri_present_flag indicates whether or not the syntax element nnpfc_application_purpose_tag_uri is present in the NNPFC SEI message. In a case that nnpfc_application_purpose_tag_uri_present_flag is 1, it indicates that the syntax element nnpfc_application_purpose_tag_uri is present in the NNPFC SEI message. In a case that nnpfc_application_purpose_tag_uri_present_flag is 0, it indicates that the syntax element nnpfc_application_purpose_tag_uri is not present in the NNPFC SEI message. In a case of not being present, nnpfc_application_purpose_tag_uri_present_flag is inferred to be equal to 0.

In a case that nnpfc_purpose is 0, the syntax element nnpfc_application_purpose_tag_uri specifies a tag URI having syntax and semantics specified in IETF RFC 4151 for identifying the purpose determined by the application of the NNPF. In a case that nnpfc_application_purpose_tag_uri is used, the purpose determined by the application of the NNPF can be uniquely identified without the need of a central registration entity.

The syntax element nnpfc_reserved_metadata_extension is not present in the bitstream conforming to the version of this specification. Note that the decoder conforming to the version of this specification ignores the presence and the value of nnpfc_reserved_metadata_extension. In a case of being present, the length (in bits) of nnpfc_reserved_metadata_extension is equal to nnpfc_num_metadata_extension_bits−numSpecifiedMetadataExtensionBits.

Note that although the method of NPL 2 enables definition of the purpose of any application through introduction of the syntax element nnpfc_application_purpose_tag_uri, there has been a problem in that how to define information required by such a specific application is unknown.

There has been a problem in that the syntax element nnpfc_application_purpose_tag_uri is not byte-aligned despite being character string information.

In view of this, the present embodiment provides a framework that enables definition of information necessary for any application.

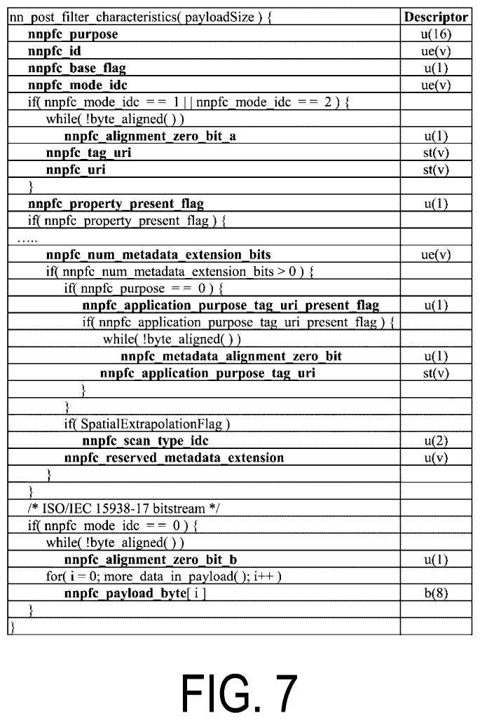

FIG. 7 is a part of syntax of a Neural Network Post-Filter Characteristic SEI message (NNPFC SEI message) according to the present embodiment.

Although in NPLs 1 and 2, only 0 and 1 are defined for the syntax element value of nnpfc_mode_idc, the value of 2 for nnpfc_mode_idc is defined. Note that an identifiable value except 0 and 1 out of values of 2 to 255 may be used.

The syntax element nnpfc_mode_idc is a value for identifying the neural network information. In a case that the value of nnpfc_mode_idc is 0, it indicates that the neural network information is included in the NNPFC SEI message, and the neural network information is in the format of the ISO/IEC 15938-17 bitstream. In a case that the value of nnpfc_mode_idc is 1, it indicates that the neural network information is in the format identified by the tag URI nnpfc_tag_uri, and is identified by the URI indicated by nnpfc_uri.

In a case that nnpfc_mode_idc is 2, it indicates that the application information for post-filter processing performed by the neural network is in the format identified by the tag URI nnpfc_tag_uri, and is identified by the URI indicated by nnpfc_uri. The values of nnpfc_mode_idc need to be in a range of 0 to 255. The values of nnpfc_mode_idc of 3 to 255 are reserved for future use, and are not present in the bitstream conforming to the version of this specification. The decoder conforming to the version of this specification ignores the NNPFC SEI message whose nnpfc_mode_idc is in a range of 3 to 255.

By extending the syntax element nnpfc_mode_idc as described above, information required by such a specific application can be defined by the tag URI and the URI, and therefore the problem can be solved.

Because alignment is not performed in bytes before the syntax element nnpfc_application_purpose_tag_uri of NPL 2, there has been a problem in that text information cannot be immediately used after decoding.

Thus, after the syntax element nnpfc_application_purpose_tag_uri_present_flag, in a case that the value of nnpfc_application_purpose_tag_uri_present_flag is 1, i.e., the syntax element nnpfc_application_purpose_tag_uri is present in the NNPFC SEI message, byte alignment is performed. Specifically, byte_aligned( ) is a function that returns whether the current coded data is in bytes, and in a case of not being in bytes, the position of bits is adjusted by inserting a syntax element nnpfc_metadata_alignment_zero_bit so that the next element is located at a byte boundary. nnpfc_metadata_alignment_zero_bit is equal to 0.

By inserting byte-aligned bits before the syntax element nnpfc_application_purpose_tag_uri as described above, the problem can be solved.

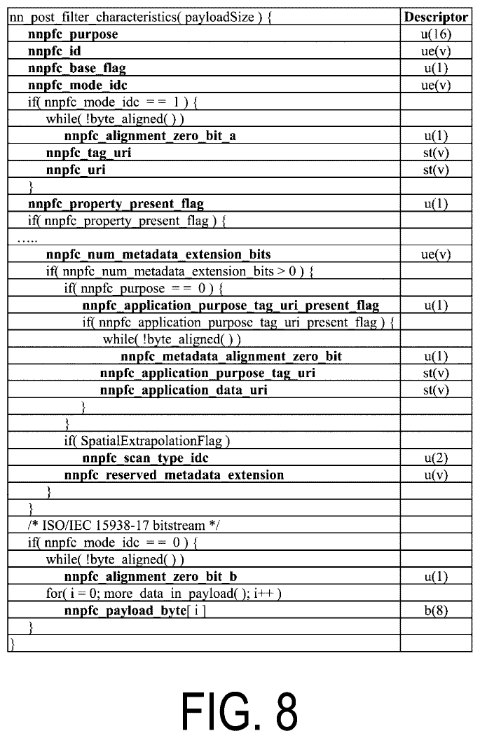

FIG. 8 is a part of syntax of another Neural Network Post-Filter Characteristic SEI message (NNPFC SEI message) according to the present embodiment.

In the present example, first, after the syntax element nnpfc_application_purpose_tag_uri_present_flag, in a case that the value of nnpfc_application_purpose_tag_uri_present_flag is 1, i.e., the syntax element nnpfc_application_purpose_tag_uri is present in the NNPFC SEI message, byte alignment is performed. Specifically, byte_aligned( ) is a function that returns whether the current coded data is in bytes, and in a case of not being in bytes, the position of bits is adjusted by inserting the syntax element nnpfc_metadata_alignment_zero_bit so that the next element is located at a byte boundary. nnpfc_metadata_alignment_zero_bit is equal to 0.

By inserting byte-aligned bits before the syntax element nnpfc_application_purpose_tag_uri as described above, the problem can be solved.

Next, in a case that nnpfc_purpose is 0, the syntax element nnpfc_application_purpose_tag_uri specifies a tag URI having syntax and semantics specified in IETF RFC 4151 for identifying the purpose determined by the application of the NNPF. In a case that nnpfc_application_purpose_tag_uri is used, the purpose determined by the application of the NNPF can be uniquely identified without the need of a central registration entity.

A syntax element nnpfc_application_data_uri identifies information related to the application identified by nnpfc_application_purpose_tag_uri. nnpfc_application_data_uri includes a URI having syntax and semantics specified in IETF Internet Standard 66, and indicates the neural network and the application information used as the base NNPF, or update information for the base NNPF having the same nnpfc_id value.

Note that, instead of nnpfc_application_data_uri, character string information of a syntax element nnpfc_application_data_string may be used.

In NPL 1 and NPL 2, the Neural Network Post-Filter Characteristic SEI message has an extendable syntax structure, but there has been a problem in that the Neural Network Post-Filter Activation SEI message cannot be extended in the syntax.

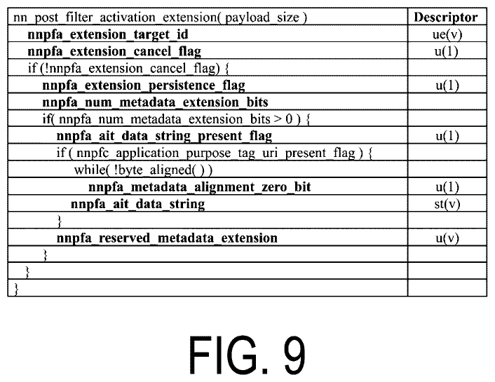

In view of this, the present embodiment illustrates a Neural Network Post-Filter Activation Extension (NNPFAE) SEI message of FIG. 9. The SEI message can be used in addition to an existing Neural Network Post-Filter Activation (NNPFA) SEI message.

The syntax elements of FIG. 9 will be described below.

In a case that the value of a syntax element nnpfa_extension_cancel_flag is 1, it indicates that the SEI message cancels persistence of a previous NNPFAE SEI message in output order. In a case that the value of nnpfae_cancel_flag is 0, it indicates that the extension information of the NNPFA persists.

A syntax element nnpfa_extension_persistence_flag specifies persistence of the NNPFAE SEI message in the current layer. In a case that the value of nnpfa_extension_persistence_flag is 0, it specifies that the NNPFAE SEI message is applied only to the current decoded picture. In a case that the value of nnpfa_extension_persistence_flag is 1, it specifies that the NNPFAE SEI message is applied to the current decoded picture, and is persistent for all the subsequent pictures in the current layer in output order until one or more of the following conditions is true.
A new CLVS in the current layer starts.
The bitstream ends.
A picture in the current layer in an AU associated with the NNPFAE SEI message is output subsequent to the current picture in output order.

A syntax element nnpfa_num_metadata_extension_bits indicates the number of bits extended for metadata. In a case that nnpfa_num_metadata_extension_bits is 0, it indicates that nnpfa_reserved_metadata_extension is not present. In a case that nnpfa_num_metadata_extension_bits is greater than 0, a variable numSpecifiedActivationMetadataExtensionBits is the number of bits indicating all syntax elements between nnpfa_num_metadata_extension_bits and nnpfa_reserved_metadata_extension.

In a case that nnpfa_num_metadata_extension_bits is greater than 0, it specifies the sum of lengths (in bits) of numSpecifiedActivationMetadataExtensionBits and nnpfa_reserved_metadata_extension. The values of nnpfa_num_metadata_extension_bits need to be in a range of numSpecifiedActivationMetadataExtensionBits to 2048. The values of nnpfa_num_metadata_extension_bits in a range of numSpecifiedActivationMetadataExtensionBits+1 to 2048 are reserved for future use, and are not present in the bitstream conforming to the version of this specification. The decoder conforming to the version of this specification allows any value of nnpfa_num_metadata_extension_bits in a range of 0 to numSpecifiedActivationMetadataExtensionBits+1 to 2048.

byte_aligned( ) is a function that returns whether the current coded data is in bytes, and in a case of not being in bytes, the position of bits is adjusted by inserting a syntax element nnpfa_metadata_alignment_zero_bit so that the next element is located at a byte boundary. nnpfa_metadata_alignment_zero_bit is equal to 0.

A syntax element nnpfa_ait_data_string is a text character string including a command prompt interpreted by a generative AI engine. A text prompt is coded as specified in ISO/IEC 10646: Information technology-Universal Coded Character Set (UCS). Here, as specified in st (v), UTF-8 of UCS may be used.

The syntax element nnpfa_reserved_metadata_extension is not present in the bitstream conforming to the version of this specification. Note that the decoder conforming to the version of this specification ignores the presence and the value of nnpfa_reserved_metadata_extension. In a case of being present, the length (in bits) of nnpfa_reserved_metadata_extension is equal to nnpfa_num_metadata_extension_bits−numSpecifiedActivationMetadataExtensionBits. The NNPFAE SEI message can be used simultaneously with the NNPFA SEI message, and in a case that extension is necessary, the NNPFAE SEI message can be additionally used in addition to the NNPFA SEI message.

The present embodiment described above illustrates that, by newly defining the NNPFAE SEI message extended by the NNPFA SEI message, and by coding and decoding the character string information including a command prompt interpreted by a generative AI engine, the image transmission system of the video coding and decoding schemes using an image generation method can be implemented.

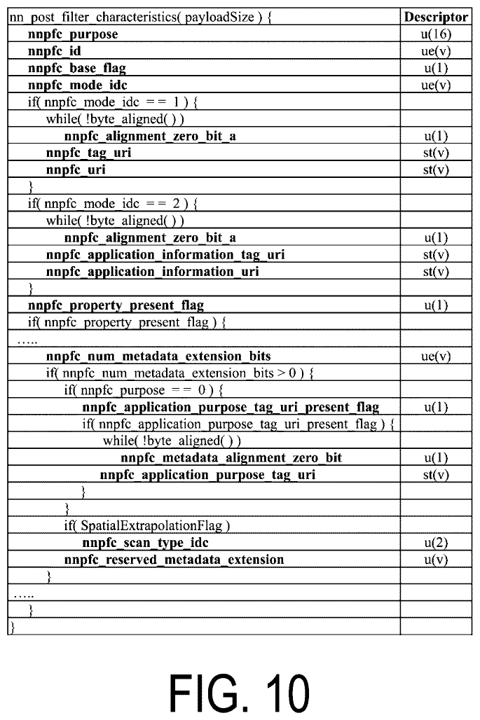

FIG. 10 is a part of syntax of another Neural Network Post-Filter Characteristic SEI message (NNPFC SEI message) according to the present embodiment.

Although in NPLs 1 and 2, only 0 and 1 are defined for the syntax element value of nnpfc_mode_idc, the value of 2 for nnpfc_mode_idc is defined as with the embodiment of FIG. 7. Note that an identifiable value except 0 and 1 out of values of 2 to 255 may be used.

The syntax element nnpfc_mode_idc is a value for identifying the neural network information. In a case that the value of nnpfc_mode_idc is 0, it indicates that the neural network information is included in the NNPFC SEI message, and the neural network information is in the format of the ISO/IEC 15938-17 bitstream. In a case that the value of nnpfc_mode_idc is 1, it indicates that the neural network information is in the format identified by the tag URI nnpfc_tag_uri, and is identified by the URI indicated by nnpfc_uri.

In a case that nnpfc_mode_idc is 2, it indicates that the application information for post-filter processing performed by the neural network is in the format identified by a tag URI nnpfc_application_information_tag_uri, and is identified by the URI indicated by nnpfc_application_information_uri.

As illustrated in FIG. 10, in a case that nnpfc_mode_idc is 2, the character string information is provided, and thus the start of the bitstream is arranged to be in bytes.

byte_aligned( ) is a function that returns whether the current coded data is in bytes, and in a case of not being in bytes, the position of bits is adjusted by inserting a syntax element nnpfc_application_information_alignment_zero_bit so that the next element is located at a byte boundary. The value of the syntax element nnpfc_application_information_alignment_zero_bit needs to be 0.

The syntax element nnpfc_application_information_tag_uri indicates a tag URI. nnpfc_application_information_tag_uri includes a tag URI having syntax and semantics defined in IETF RFC 4151, and indicates the format of the application information used as the base NNPF and its related information, or update information to be applied to the base NNPF having the same nnpfc_id value specified by nnpfc_application_information_uri.

Note that, in a case that nnpfc_application_information_tag_uri is used, the format of the application information specified by nnpfc_application_information_uri can be uniquely identified without the need of a central registration entity.

For example, in a case that nnpfc_application_information_tag_uri is equal to “tag: stable.diffusion.webui.170”, it indicates that the application information identified by nnpfc_application_information_uri conforms to the application information generated in Stable Diffusion Webui 1.70.

The syntax element nnpfc_application_information_uri indicates a URI for identifying the application information. nnpfc_application_information_uri includes a URI having syntax and semantics specified in IETF Internet Standard 66, and indicates the application information used as the base NNPF, or update information for the base NNPF having the same nnpfc_id value. By extending the syntax element nnpfc_mode_idc as described above, information required by such a specific application can be independently defined by the tag URI and the URI, and therefore the problem can be solved.

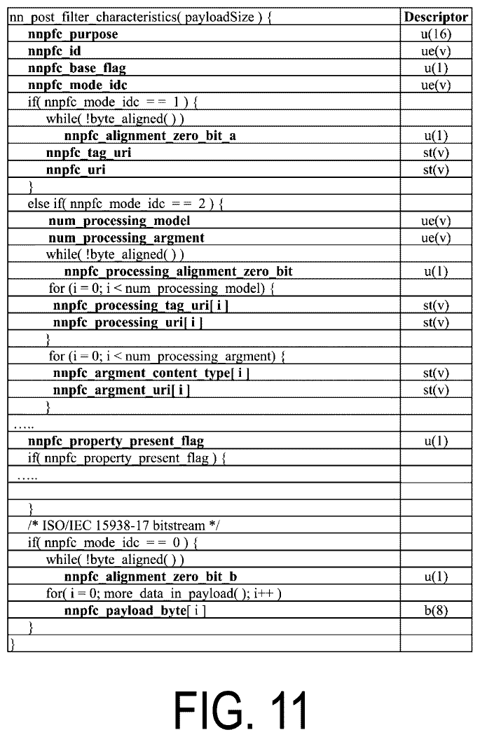

FIG. 11 is a part of syntax of another Neural Network Post-Filter Characteristic SEI message (NNPFC SEI message) according to the present embodiment.

A syntax element num_processing_model indicates the number of models for neural network post-filter processing in an application.

A syntax element num_processing_argment indicates the number of arguments for neural network post-filter processing in an application.

As illustrated in FIG. 11, before the character string information, the start of the bitstream is arranged to be in bytes.

byte_aligned( ) is a function that returns whether the current coded data is in bytes, and in a case of not being in bytes, the position of bits is adjusted by inserting a syntax element nnpfc_processing_alignment_zero_bit so that the next element is located at a byte boundary. The value of the syntax element nnpfc_processing_alignment_zero_bit needs to be 0.

For the number of num_processing_model, a syntax element nnpfc_processing_tag_uri[i] and a syntax element nnpfc_processing_uri[i] from i=0 to i=num_processing_model−1 are coded and decoded.

The syntax element nnpfc_processing_tag_uri[i] indicates a tag URI. nnpfc_processing_tag_uri[i] includes a tag URI having syntax and semantics defined in IETF RFC 4151, and indicates the format of the application information used as the base NNPF and its related information, or update information to be applied to the base NNPF having the same nnpfc_id value specified by nnpfc_processing_tag_uri[i].

Note that, in a case that nnpfc_processing_tag_uri[i] is used, the format of the application information specified by nnpfc_processing_tag_uri[i] can be uniquely identified without the need of a central registration entity.

The syntax element nnpfc_processing_uri[i] indicates a URI for identifying the application information. nnpfc_processing_uri[i] includes a URI having syntax and semantics specified in IETF Internet Standard 66, and indicates the application information used as the base NNPF, or update information for the base NNPF having the same nnpfc_id value.

For the number of num_processing_argment, a syntax element nnpfc_argment_content_type[i] and a syntax element nnpfc_argment_uri[i] from i=0 to i=num_processing_argment−1 are coded and decoded.

The syntax element nnpfc_argment_content_type[i] indicates a character string indicating a type of argument information of the application information.

The syntax element nnpfc_argment_uri[i] indicates a URI for identifying the application information. nnpfc_argment_uri includes a URI having syntax and semantics specified in IETF Internet Standard 66, and indicates the argument information of the application used as the base NNPF, or update information for the base NNPF having the same nnpfc_id value.

By extending the syntax element nnpfc_mode_idc as described above, information required by such a specific application can be independently defined by the tag URI and the URI, and therefore the problem can be solved.

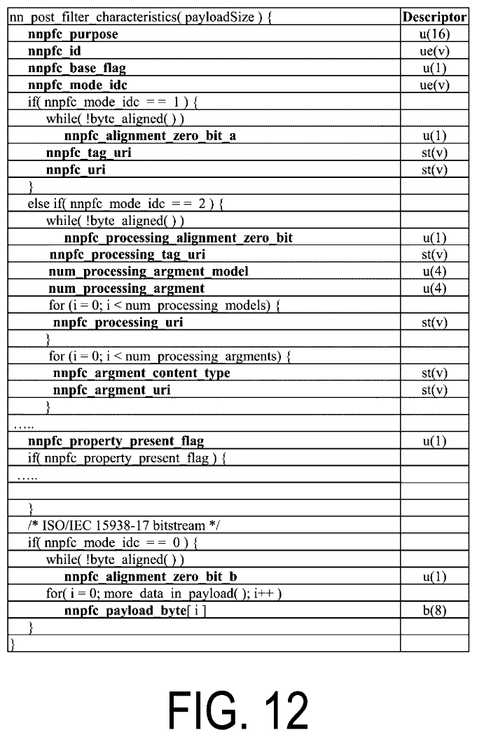

FIG. 12 is a part of syntax of another Neural Network Post-Filter Characteristic SEI message (NNPFC SEI message) according to the present embodiment.

As illustrated in FIG. 12, in a case that nnpfc_mode_idc is 2, the character string information is provided, and thus the start of the bitstream is arranged to be in bytes.

byte_aligned( ) is a function that returns whether the current coded data is in bytes, and in a case of not being in bytes, the position of bits is adjusted by inserting the syntax element nnpfc_processing_alignment_zero_bit so that the next element is located at a byte boundary. The value of the syntax element nnpfc_processing_alignment_zero_bit needs to be 0.

The syntax element nnpfc_processing_tag_uri indicates a tag URI. nnpfc_processing_tag_uri includes a tag URI having syntax and semantics defined in IETF RFC 4151, and indicates the format of the application information used as the base NNPF and its related information, or update information to be applied to the base NNPF having the same nnpfc_id value specified by nnpfc_processing_tag_uri.

Note that, in a case that nnpfc_processing_tag_uri is used, the format of the application information specified by nnpfc_processing_tag_uri can be uniquely identified without the need of a central registration entity.

The syntax element num_processing_model indicates the number of models for post-processing in an application.

The syntax element num_processing_argment indicates the number of arguments for post-processing in an application.

The syntax element nnpfc_processing_tag_uri indicates a tag URI. nnpfc_processing_tag_uri includes a tag URI having syntax and semantics defined in IETF RFC 4151, and indicates the format of the application information used as the base NNPF and its related information, or update information to be applied to the base NNPF having the same nnpfc_id value specified by nnpfc_processing_tag_uri.

Note that, in a case that nnpfc_processing_tag_uri is used, the format of the application information specified by nnpfc_processing_tag_uri can be uniquely identified without the need of a central registration entity.

The syntax element num_processing_model indicates the number of models for neural network post-filter processing in an application.

The syntax element num_processing_argment indicates the number of arguments for neural network post-filter processing in an application.

For the number of num_processing_model, the syntax element nnpfc_processing_uri[i] from i=0 to i=num_processing_model−1 is coded and decoded.

The syntax element nnpfc_processing_uri[i] indicates a URI for identifying the application information. nnpfc_processing_uri[i] includes a URI having syntax and semantics specified in IETF Internet Standard 66, and indicates the application information used as the base NNPF, or update information for the base NNPF having the same nnpfc_id value.

For the number of num_processing_argment, the syntax element nnpfc_argment_content_type[i] and the syntax element nnpfc_argment_uri[i] from i=0 to i=num_processing_argment−1 are coded and decoded.

The syntax element nnpfc_argment_content_type[i] indicates a character string indicating a type of argument information of the application information.

The syntax element nnpfc_argment_uri[i] indicates a URI for identifying the application information. nnpfc_argment_uri includes a URI having syntax and semantics specified in IETF Internet Standard 66, and indicates the argument information of the application used as the base NNPF, or update information for the base NNPF having the same nnpfc_id value.

By extending the syntax element nnpfc_mode_idc as described above, information required by such a specific application can be independently defined by the tag URI and the URI, and therefore the problem can be solved.

Note that a part or all of the video coding apparatus 10 and the video decoding apparatus 30 in the above-described embodiments may be implemented by a computer. In that case, this configuration may be realized by recording a program for realizing such control functions on a computer-readable recording medium and causing a computer system to read and perform the program recorded on the recording medium. Note that the “computer system” described here refers to a computer system built into either the video coding apparatus 10 and the video decoding apparatus 30 and is assumed to include an OS and hardware components such as a peripheral apparatus. In addition, the “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

A part or all of the video coding apparatus 10 and the video decoding apparatus 30 in the embodiment described above may be realized as an integrated circuit such as a Large Scale Integration (LSI). Each function block of the video coding apparatus 10 and the video decoding apparatus 30 may be individually realized as processors, or part or all may be integrated into processors. In addition, the circuit integration technique is not limited to LSI, and implementation as a dedicated circuit or a multi-purpose processor may be adopted. In addition, in a case that a circuit integration technology that replaces LSI appears as the semiconductor technologies advance, an integrated circuit based on that technology may be used.

Although an embodiment of the present invention has been described above in detail with reference to the drawings, the specific configurations thereof are not limited to those described above and various design changes or the like can be made without departing from the spirit of the invention.

An embodiment of the present invention is not limited to the embodiments described above and various changes can be made within the scope indicated by the claims. That is, embodiments obtained by combining technical measures appropriately modified within the scope indicated by the claims are also included in the technical scope of the present invention.

### Industrial Applicability

The embodiments of the present invention can be preferably applied to a video decoding apparatus for decoding coded data in which an image signal is coded, and a video coding apparatus for generating coded data in which image data is coded. In addition, the embodiments of the present invention can be preferably applied to a data structure of coded data generated by the video coding apparatus and referred to by the video decoding apparatus.

### REFERENCE SIGNS LIST

1 Image transmission system
10 Video coding apparatus
101 Image coding apparatus
102 Generative information creation apparatus
1021 Generative information creator
1023, 303 Image generation processing apparatus
1022 Coding controller
103 Generative information coding apparatus
1031 Supplemental extension information coder
1032 URI data coder
1033 URI data saver
20 Transmission network
30 Video decoding apparatus
301 Image decoding apparatus
302 Generative information decoding apparatus
3021 Supplemental extension information decoder
3022 URI data decoder
3023 URI data loader
303 Image generation processing apparatus
3031 Image generator
3032 Controller
3033 Control image generator
40 Image display apparatus

1. A video decoding apparatus for decoding coded data, the video decoding apparatus comprising:
an information decoder that decodes a Neural Network Post-Filter Characteristic (NNPFC) SEI message and a Neural Network Post-Filter Activation Extension (NNPFAE) SEI message;
wherein
the NNPFC SEI message includes:
a flag indicating a uri syntax element is present in the NNPFC SEI message, and
in a case that the flag is equal to true,
the uri syntax element specifying a tag uri, and
a zero bit syntax element if coded data is not in bytes,
the NNPFAE SEI message includes a syntax element specifying a text string prompt, and
the uri syntax element follows the zero bit syntax element.

2. A video coding apparatus for coding video data, the video coding apparatus comprising:
an information coder that codes a Neural Network Post-Filter Characteristic (NNPFC) SEI message and a Neural Network Post-Filter Activation Extension (NNPFAE) SEI message;
wherein
the NNPFC SEI message includes:
a flag indicating a uri syntax element is present in the NNPFC SEI message, and
in a case that the flag is equal to true,
the uri syntax element specifying a tag uri, and
a zero bit syntax element if coded data is not in bytes,
the NNPFAE SEI message includes a syntax element specifying a text string prompt, and
the uri syntax element follows the zero bit syntax element.

3. A non-transitory computer readable medium storing a bitstream generated by coding video data, the bitstream being decoded by processes of:
decoding, from the bitstream, a Neural Network Post-Filter Characteristic (NNPFC) SEI message and a Neural Network Post-Filter Activation Extension (NNPFAE) SEI message;
wherein
the NNPFC SEI message includes:
a flag indicating a uri syntax element is present in the NNPFC SEI message, and
in a case that the flag is equal to true,
the uri syntax element specifying a tag uri, and
a zero bit syntax element if coded data is not in bytes,
the NNPFAE SEI message includes a syntax element specifying a text string prompt, and
the uri syntax element follows the zero bit syntax element.
